(19) United States
(12) Patent Application Publication
(10) Pub. No.: US 2019/0008102 A1
(43) Pub. Date: Jan. 10, 2019

(54) Dripper Gripper

(71) Applicants: Garry McCaslin, Shafter, CA (US); Dustin McCaslin, Shafter, CA (US)

(72) Inventors: Garry McCaslin, Shafter, CA (US); Dustin McCaslin, Shafter, CA (US)

(21) Appl. No.: 16/129,639

(22) Filed: Sep. 12, 2018

Related U.S. Application Data
(63) Continuation-in-part of application No. 15/793,748, filed on Oct. 25, 2017.
Application No. 15/793,748 is a division of application No. 15/169,293, filed on May 31, 2016, now abandoned.
(60) Provisional application No. 62/168,409, filed on May 29, 2015.
(60) Provisional application No. 62/292,780, filed on Feb. 8, 2016.

(51) Int. Cl. A01G 25/02

(52) U.S. Cl. CPC A01G 25/02

(57) ABSTRACT

A water line support device includes a pair of stakes that extend perpendicularly downward from a horizontal support member and a plurality of water line retention mechanisms that may be positioned on the top or bottom side of the horizontal member. In simple form, the plurality of integral retention mechanisms have a recessed channel that is oriented parallel to the ground and perpendicular to the horizontal member. The horizontal member has a top side and a bottom side connected on opposite sides of a middle support such that the top side, middle support and bottom side form an I-beam configuration when viewed as a cross section of the horizontal member. The middle support can be reinforced or braced with diagonal supports that also are connected to and support the top side and the bottom side of the horizontal member. A logo can be added to the horizontal support member.

### RELATED APPLICATIONS

This application is a Continuation-in-part of, and claims the benefit of priority to, the United States patent application for “Dripper Gripper,” Ser. No. 15/726,544, filed on Oct. 6, 2017, which is a Divisional Application of, and claims the benefit of priority to, the United States patent application for “Dripper Gripper,” Ser. No. 15/169,293, filed on May 31, 2016. That patent application is a conversion of, and claims the benefit of priority to, the United States Provisional patent application for “Dripper Gripper,” Ser. No. 62/168,409, filed on May 29, 2015, and also is a conversion of, and claims the benefit of priority to, the United States Provisional patent application for “Dripper Gripper,” Ser. No. 62/292,780, filed on Feb. 8, 2016. The three referenced applications are incorporated fully herein by this reference, FIELD OF INVENTION

The present invention relates to an agricultural support device and system. More particularly, the present invention pertains to a water line support device that is driven into the ground. The invention may securely retain water lines along the ground in an orderly fashion and resist unwanted rotation and tangling of water lines. Additionally, the water line support device has a plurality of water line retention mechanisms for retaining individual water lines therein, and a pair of stakes that secure the device to the ground. The invention provides the users with a superior means of retaining and supporting hose and water lines.

### BACKGROUND OF INVENTION

The present invention relates to a water line support device. In many farm, orchid, and agricultural estates, water and other fluids need to be transported and delivered to plants and vegetation far from a water source. Typically, hoses and water lines are utilized to deliver the water from the source to sprinklers in the fields. The sprinklers then disperse the water onto the desired area. Various water and hose line retention devices can be used to organize and arrange the various lines. It is important to organize the hoses to ensure that the hoses are not destroyed by tractors or other vehicles that my run over the hoses. Farmers often bury the hoses to keep them in place out of path of travel of tractors. However, the practice of burying the irrigation hoses often leads to damage from pests, such as gophers.

Over the years, there have been other variations of hose and water line retention devices. Most commonly, these devices include a stake member that is driven into the ground, while at the same time is rigid and removable. These devices generally comprise a rigid metal stake with a substantially pointed end that is configured for insertion into the ground, and which have a retention mechanism adapted to retain a water line. These metal stakes are prone to failure from rust or metal fatigue.

Hose and water line retention devices are frequently inserted manually into the ground with the stake end facing downwardly. The user may then selectively insert a hose or water line within the retention mechanism. The hose and water lines are typically tubular, hollow, and flexible cylinders that are adapted to transport and house fluid therein. Hoses and water lines may be attached to a water source, such as a spigot at a first end, and to a dispensing apparatus, such as a sprinkler at the second end. The hose and water line retention devices are selectively placed between the two ends to prevent them from twisting. The retention devices also enable a farmer to organize the lines in such a way as to ensure that tractors and other vehicles do not unnecessarily run over and damage the water line. In addition, the retention devices enable a farmer to more precisely deliver the fluid contents to a desired location, wasting less water in the process.

While these known prior art retention devices are a convenient way to retain hose and water lines, they do not work very well with certain gauge/capacity water lines because when large volumes of water flow through hoses, it exerts a force on the single stake retention device that may dislodge the hose from the device and/or remove the stake from the ground. Heretofore, various forms water line retention devices have been constructed with retention mechanisms and stakes. These prior art devices are typically single stake devices with a single retention mechanism located on the side or underside of the device. These devices, however, do not allow for multiple hose and water lines to be individually secured within a plurality of retention mechanisms on the same device. Also, these conventional retention devices are easily dislodged from the ground and are simply not robust enough for commercial application in a commercial orchard. Although it is a goal to minimize impact on retention devices from orchard equipment, such as tractors, trucks, quads, trailers, carts, shakers, receivers and elevators, such impacts are inevitable, particularly during high traffic periods such as harvest time. Conventional retention devices are simply not sufficiently robust to withstand forces exerted by orchard equipment running over the retention devices or running over the water lines themselves. The result of such impacts are often damage to the retention device, dislodgment of the retention device, and or dislodgment of the water line from the retention device.

Therefore, where there is a need to use multiple water lines, such as in a commercial orchard, the prior art retention devices lack the ability to retain multiple lines within the same device. This in turn requires installation of more retention devices and less organization. An additional shortcoming of the prior art is the relative location of the retention mechanism on the prior art devices, which are not in an optimal location for retaining, securing, and changing a water line held therein.

In light of the above, it would be advantageous to provide a water line support device with multiple stakes capable of retaining multiple lines within the same device. It would be further advantageous to provide to a water line support device with an optimal location for securely retaining a water line held therein while also facilitating easy removal and insertion of a water line in the water line support device. In addition, it would be advantageous to provide a water line support device with an anchor system that limits dislodgment from the ground that is also sufficiently robust to withstand the forces from both high flow rates in the water line as well as forces resulting from orchard equipment, such as tractors, trucks, quads, trailers, carts, shakers, receivers and elevators running over the water line support device or the water line held therein.

### SUMMARY OF THE INVENTION

The present invention offers a water line support device that includes a pair of stakes that extend perpendicularly downward from a horizontal support member and a plurality of water line retention mechanisms. The plurality of retention mechanisms may be positioned on the top side of the horizontal member. In simple form, the plurality of integral retention mechanisms have a recessed channel that is oriented parallel to the ground and perpendicular to the horizontal member.

The horizontal member has a top side and a bottom side connected on opposite sides of a middle support such that the top side, middle support and bottom side form an I-beam configuration when viewed as a cross section of the horizontal member. The middle support can be reinforced or braced with diagonal supports that also are connected to and support the top side and the bottom side of the horizontal member. A logo can be added to the horizontal support member.

In an embodiment, the stakes are positioned with respect to one another so as to trifurcate the horizontal support member into three equal portions; a first third portion, a second third portion and a middle third portion. The stakes have an elongated member with a substantially pointed distal end that is adapted to penetrate and remain in the ground. The stakes are connected to the bottom side of the horizontal member, opposite the substantially pointed distal end of the elongated member. Stake flare supports can optionally be provided to connect the elongated body of the stakes and bottom side of the horizontal support member. The stakes may also be provided with a projected member that runs along the length of the elongated member. In an embodiment, a projected member can be provided on either side of the elongated member such that the two projected members coupled with the elongated member form an x″ cross section in the stake. A striking surface texture is provided on the top side of the horizontal support member opposite the stakes to enable a user to easily drive the stakes into the ground using a foot or tool such as a hammer.

The integral retention mechanisms have a recessed channel that has a hollow partially complete circle within the middle support of the horizontal member that has an entrance way through an aperture in the top side of the horizontal member. Alternatively, or additionally, the integral retention mechanisms may be formed on the bottom side of the horizontal member. The entrance way has two curved members that are biased towards each other. In use, a water line is deformed to pass the two curved members so as to rest in the recessed channel. As the water line expands to its original circular geometry, it is retained in the recessed channel by the two curved members. In one embodiment, the integral retention mechanisms are located within the first third portion and second third portion of the horizontal member.

In an alternative embodiment, the present invention offers a water line support device that has two stakes connected together at a body with a hose or water line receiving aperture located in the body between the two stakes. The hose or ater line receiving aperture has a reinforced surface. The top of the reinforced surface has a textured surface for striking with a foot, hammer or other tool when driving the alternative water line support device into the ground.

The stakes extend away from the body and are substantially parallel to one another to define a channel. The channel of the stakes has an inner edge formed with a reinforced rail that extends along the surface of each stake and also along an interior wall of the aperture in the body. The reinforced rail is transverse to the stakes and is dimensioned so as to be flush with the front and back of the reinforced surface and taper to a point at each of the ends of the reinforced rail. The reinforced rail reinforces the stakes further reinforces the interior edge of the water line receiving aperture. The stakes are also formed with pointed tips that enable the water support device to be easily driven into the ground when struck at the textured surface.

In use, the stakes are flexed at the body to an open position to enable a user to pass a water line or hose through the channel and into the hose or water line receiving aperture. The stakes then return to their original un-flexed position and retain the water line within the hose or water line receiving aperture. The stakes are held in the original un-flexed position when driven into the ground, thus securing the hose or water line within the hose or water line receiving aperture.

In an alternative embodiment, the present invention offers a water support device that has a body with two stakes with an anchor system. As with the preceding embodiment, the body is formed with a central member having a water line receiving aperture open between the first and second stakes, which form a channel leading to the water line receiving aperture.

The water line receiving aperture is reinforced by a body exterior reinforcement and a body interior reinforcement. The body exterior reinforcement and the body interior reinforcement are each transverse to the central member. The body exterior reinforcement encircles the exterior of the central member and has a textured top to serve as a striking surface. The body interior reinforcement is formed along the entire length of the surface edge of the water line receiving aperture. The body exterior reinforcement and the body interior reinforcement are connected together at either side of the channel at the entrance to the water line receiving aperture. It is preferable for the width of the channel and the width of the entrance to the water line receiving aperture to be slightly less than the diameter of the water line intended for use.

The stakes each have an exterior reinforced member and an interior reinforcement member that are opposite one another and transverse to the stakes. The exterior reinforced members, stakes, and interior reinforced members terminate at the body exterior reinforcement at one end and in tapered tips at the opposite end. The interior reinforced members are further formed with retention tabs that extend into the channel. Semi-circular anchors are formed between the stakes and the exterior reinforced members and the stakes and also between the interior reinforced members and the stakes.

During use, the stakes are flexed about the body sufficiently to enable a flexible water line to pass between the retention tabs, into the channel and ultimately into the water line receiving aperture. In order to pass the water line into the water line receiving aperture, the water line must be slightly deformed so as to fit into the entrance of the water line receiving aperture. Once in the water line receiving aperture, the water line returns to its ordinary configuration and the water line support device is ready for insertion into the ground by striking the textured surface with a striking object, such as a hammer. The textured surface limits slippage of the striking object when striking the water line support device into the ground. The water line support device is driven into the ground until approximately ⅔ of the length of the stakes are under the ground surface thereby ensuring that the water line is held above the ground surface. Alternatively, the water line support device can be driven into the ground up to the bottom of the body exterior reinforcement. At either depth, over time, soil settlement above the semi-circular anchors and the retention tabs increases the force necessary to remove the water line support device from the ground.

### BRIEF DESCRIPTION OF DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front view of the hose and water line support device of the present invention showing the two separate stakes extending from the body and having a point to facilitate positioning of the hose and water line support device into the ground;

FIG. 2 is a lower perspective view of the hose and water line support device of the present invention showing a body having two stakes apart and extending perpendicular from the body and tapered to a point to facilitate insertion of the hose and water line support device of the present invention into position on the ground, and also formed with multiple hose-receiving apertures sized to securely receive a hose or water line and maintain that hose or water line above the ground;

FIG. 3 is a front plan view of the hose and water line support device of the present invention showing a first hose being positioned above an integral retention mechanism and showing a second hose within an integral retention mechanism;

FIG. 4 is a side view of a first hose and water line support device and a second hose and water line support device and showing a hose secured in an integral retention mechanism in each device such that the hose is firmly held above ground to enable an almond to pass freely beneath the hose;

FIG. 5 is an isometric view of an alternative embodiment of the present invention that includes a body formed with a hose or water line receiving aperture;

FIG. 6 is a front view of the alternative embodiment shown in FIG. 5 and showing stakes flexing at body to an open position to allow placement of a hose into the aperture:

FIG. 7 is a front view of the alternative embodiment shown in FIGS. 5 and 6 and showing the hose and water line support device secured in the ground by its stakes and securely holding a hose within the aperture;

FIG. 8 is a front view of an alternative embodiment of the hose and water line support device of the present invention having a body formed with integral retention mechanisms formed on both the upper and lower side of the body and showing a single stake extending from the body and having a point to facilitate positioning of the hose and water line support device into the ground;

FIG. 9 is a front view of an alternative embodiment of a water support device that includes a body formed with two stakes on either side of a water line receiving aperture with each stake having a retention tab and ribbed anchors;

FIG. 10 is a rear view of the water support device shown in FIG. 9 showing the vertical body supplemental bracing between the body exterior reinforcement and the body interior reinforcement of the body;

FIG. 11 is a side view of the water support device shown in FIG. 9 showing the exterior stake reinforcement member transversely connected to and extending along a primary stake member, one end connected to the body exterior reinforcement opposite the other end terminating in a pointed tip flush with the side of the primary stake member;

FIG. 12 is a top view of the water support device shown in FIG. 9 showing a textured surface on the upper horizontal portion of the body exterior reinforcement to facilitate contact between a striking tool, such as a hammer and the textured surface;

FIG. 13 is a cross sectional view of the water support device shown in FIG. 10 along the lines 13-13 showing the central placement of the central member between the body exterior reinforcement and the body interior reinforcement;

FIG. 14 is a bottom view of the water support device shown in FIG. 9 showing the first ribbed anchor, the second ribbed anchor and the third ribbed anchor, each of which having a semi-circular structure;

FIG. 15 is a front view of the water support device shown in FIG. 9 showing a close up view of the stakes to showcase the preferred spacing between the first ribbed anchor, the second ribbed anchor and the third ribbed anchor and to further showcase the positioning of the anchors with respect to the stakes;

FIG. 16 is a front isometric view of the water support device shown in FIG. 9;

FIG. 17 is a front view of the water support device shown in FIG. 9 showing stakes flexing at body to an open position to allow placement of an irrigation line between the retention tabs and into the water line receiving aperture;

FIG. 18 is a front view of the water support device shown in FIG. 9 showing the stakes returned to their normal unflexed position with the irrigation line secured within the water line receiving aperture and ready to be driven into the ground; and

FIG. 19 is a front view of the water support device showing in FIG. 9 showing the water line secured within the aperture above a ground surface with the anchors and retention tabs working in combination to minimize the risk of dislodgement from the ground in the event that the water support device is struck by orchard equipment.

### DETAILED DESCRIPTION OF A PREFERRED EMBODIMENT

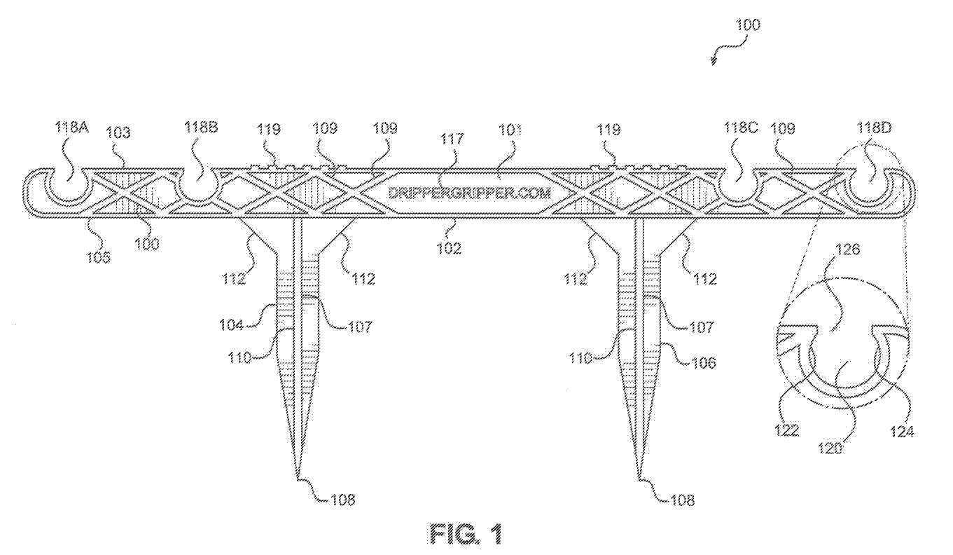

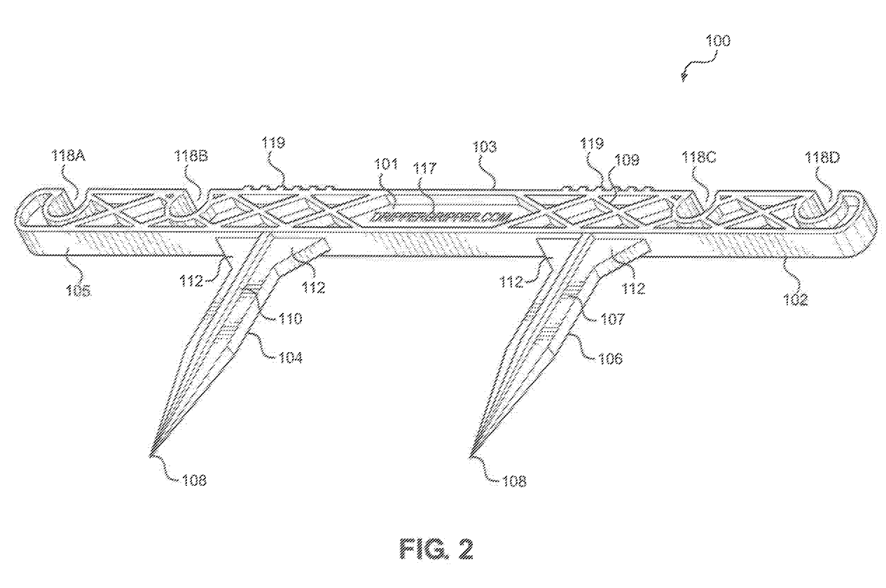

Referring now to FIG. 1 and FIG. 2, there is shown a front view and lower perspective view of the hose and water line support device 100. The hose and water line support device 100 comprises a horizontal support member 102 having a top side 103 and a bottom side 105 connected on opposite sides of a middle support 101 such that the top side 103, middle support 101 and bottom side 105 form a typical I-beam configuration. A first stake 104 and a second stake 106 each extend perpendicularly downward from the bottom side 105 of horizontal support member 102. In an embodiment, first stake 104 and second stake 106 are positioned with respect to one another so as to trifurcate the horizontal support member 102 into three equal portions; a first third portion, middle third portion and a final third portion. Overall, the device is shaped like the Greek letter “π” (Pi). Middle support surface 101 is shown braced with diagonal supports 109. Diagonal supports 109 also support the top side 103 and bottom side 105 of horizontal support member 102. A logo 117 can also be placed on middle support surface 101.

First stake 104 and second stake 106 each is comprised of an elongated member 107 with a substantially pointed distal end 108 that is adapted to penetrate and remain in the ground 300. The elongated member may have a circular, rectangular, or polygonal cross section. A projected member 110, disposed toward each distal end 108 of stakes 104 and 106, serves to increase the frictional engagement between the stakes 104 and 106 and ground 300, and provide resistance to uplifting forces. A second projected member 111 (not shown) can be located on stakes 104 and 106 on the opposite side of projected member 110. The elongated member 107 coupled with projected member 110 and second projected member 111 form “X” shaped cross sectional area for stakes 104 and 106. Stakes 104 and 106 can also be equipped with stake flare supports 112 opposite distal end 108. Stake flare supports 112 ensure strong bond between horizontal support member 102 and stakes 104 and 106. The stake flare supports 112 coupled with projected member 110 also increase the torsional rigidity of the stakes 104 and 106 to decrease risk of rotation of the horizontal support member 102 with respect to stakes 104 or 106. The hose and water line support device 100 may be constructed from plastic, metal, wood, or other similarly semi-rigid material. The first and second stakes 104 and 106 are adapted to secure the hose and water line support device 100 to the ground 300.

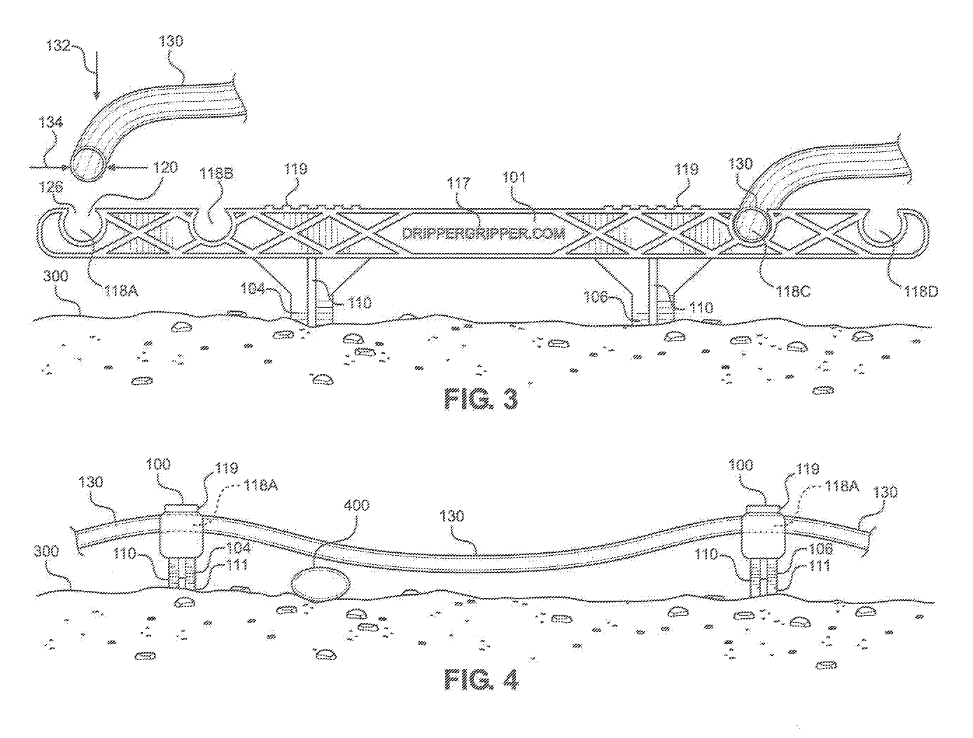

The horizontal support member 102 has a plurality of integral retention mechanisms 118A, 118B, 118C and 118D. The plurality of integral retention mechanisms 118A. 118B. 1180 and 118D are each sized to receive and secure a drip line, water line, and the like. In an embodiment, integral retention mechanisms 118A and 118B are located in the first third portion of the horizontal support member 102. Similarly, integral retention mechanisms 118C and 118D are located in the final third portion. Each integral retention mechanism 118A, 118B, 1180, 118D consists of a recessed channel 120 that is oriented perpendicular to the horizontal member 102 and parallel to the ground 300 (Shown in FIGS. 3 and 4). This recessed channel 120 forms a hollow, partially complete circle that has an entrance way. The entrance way consists of a pair of curved members 122 and 124 biased toward each other, and a recess channel 120 accessible by an aperture 126 on the top side 103 of the horizontal member 102.

The top surface 103 of the horizontal support member 102 has striking surface texture 119 located opposite the first and second stakes 104 and 106 making the hose and water line support device 100 adapted to be stepped on or otherwise pressed downwardly. The striking surface texture 119 also provides a user with a visual target to strike with a hammer or his or her foot when driving stakes 104 and 106 into the ground 300 as well as increase friction to prevent slippage of the hammer head or foot when striking the hose and water line support device 100.

Referring now to FIG. 3, in operation, stakes 104 and 106 are pressed into the ground 300 by apply pressure on striking surfaces 119. When inserted into the ground, the pair of stakes 104 and 106 resist rotational and torsional forces that may act against the hose and water line support device 100. Next, the retaining mechanisms 118A, 118B, 1180 and 118D receive a tubular member therein, such as an irrigation hose 130. Sufficient pressure is applied to the hose 130 in direction 132 such that the walls of irrigation hose 130 are deformed in directions 134 when passing through aperture 126 in retaining mechanism 118A. Once the hose 130 has passed through the aperture 126, the hose 130 returns to its original configuration and rests securely within the recessed channel 120.

The inclusion of multiple retention mechanisms 118 on the first third and the final third of the horizontal support member 102 provides the ability to move drip lines after the hose and water line support device 100 has been secured to the ground 300. More specifically, irrigation hoses 130 can initially be placed in support members 1188 and 118C and then as the irrigated trees and their roots grow beyond the location of irrigation hoses 130, those irrigation hoses 130 can be moved from support members 118E and 1180 to 118A and 118D respectively to allow irrigation water to again reach the grown roots of the trees.

Referring now to FIG. 4, a first hose and water line support device 100 is shown connected to a second hose and water line support device 100 by way of hose 130. The hose 130 is held sufficiently above ground 300 to enable nut 400 to pass underneath the hose 130 without interference from the hose 130. In addition, the act of holding hose 130 above or on the ground reduces the likelihood of gopher damage to the hose 130.

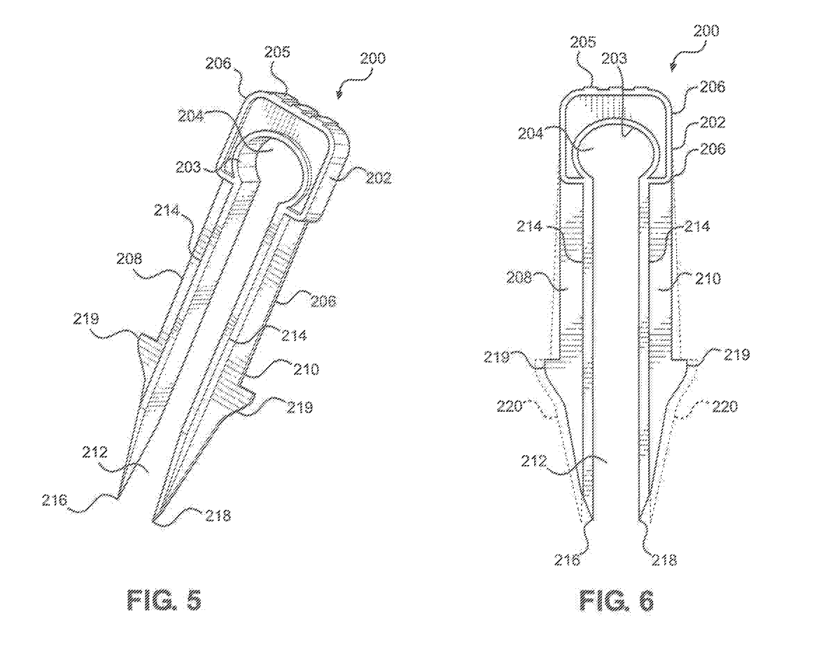

Referring now to FIG. 5, a single hose and water line support device of the present invention is shown and generally designated 200. Hose and water line support device 200 includes a body 202 formed with a hose or water line receiving aperture 204 and having a reinforced surface 206 to provide a region of the device 200 capable of withstanding the pounding of the device into the soil. The top of the reinforced surface 206 has textured surface 205.

Extending away from body 202 are a pair of stakes 208 and 210 which are substantially parallel and spaced apart to define a channel 212. The stakes 208 and 210 adjacent the inner edge of channel 212 are formed with a reinforced rail 214 to provide additional strength to the device 200 as it is inserted into the soil. The reinforced rail 214 extends along the inner surface of each stake 208 and 210 as well as the interior wall 203 of aperture 204. Additionally, stakes 208 and 210 are formed with pointed tips 216 and 218 respectively to facilitate the placement of the stakes into the soil 300.

From FIG. 6 it can be appreciated that stakes 208 and 210 can flex at body 202 to an open position 220 (shown in dashed lines) to facilitate the placement of the hose or water line within the device 200. With this flexibility, a hose or water line 250 can be positioned on the ground, and the hose and water line support device 200 may be positioned over the hose or water line, separated to accept the hose or waterline within channel 212 and into position within the aperture 204 of body 202.

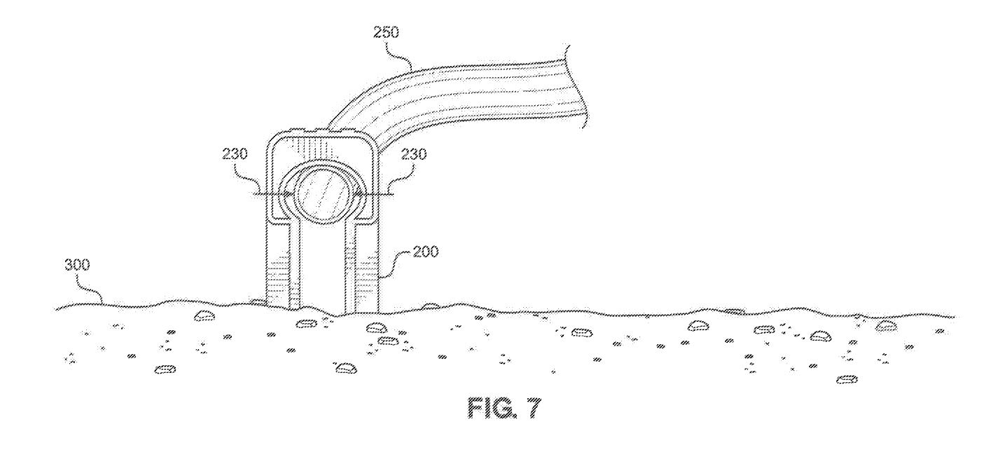

In application, device 200 is used as shown in FIG. 7. A hose or water line 250 is shown positioned in aperture 204 of device 200. In order to place the hose or water line 250 into aperture 204, the stakes 208 and 210 are first flexed to open position 220 as shown in FIG. 6. Once flexed into the open position 220, the hose or water line 250 easily is passed up through channel 212. The hose or water line 250 is then compressed in direction 230 to enable the hose or water line 250 to pass into aperture 204. Next, the stakes 208 and 210 are placed into soil 300, such as by pounding on the reinforced area 206 at textured surface 205 of the device 200 driving it into the soil 300. It is not necessary to completely bury stakes 208 and 210. The hose or water line 250 is held securely within aperture 204 or device 200.

Referring now to FIG. 8, an alternative embodiment of the hose and water line support device is generally designated 350. Hose and water line support device 350 comprises a horizontal support member 351 having a top side 352 and a bottom side 353 connected on opposite sides of a middle support 354 such that the top side 352, middle support 354 and bottom side 353 form a typical I-beam configuration. A first stake 355 extends perpendicularly downward from the bottom side 353 of horizontal support member 351. Middle support surface 351 is shown braced with diagonal supports 360. Diagonal supports 360* also support the top side 354 and bottom side 353 of horizontal support member 351.

Stake 355 is comprised of an elongated member, as was more fully discussed above, with a substantially pointed distal end that is adapted to penetrate and remain in the ground.

The horizontal support member 351 has a plurality of integral retention mechanisms 362 and 364 formed adjacent the top side 352, and 366 and 368 formed adjacent the bottom side 353. The plurality of integral retention mechanisms 362, 364, 366, 368 are each sized to receive and secure a drip line, water line, and the like. Each integral retention mechanism 362, 364, 366, 368, as more fully described above, consists of a recessed channel that is oriented perpendicular to the horizontal member 351 and parallel to the ground 300 (Shown in FIGS. 3 and 4).

As more fully discussed above, this recessed channel forms a hollow, partially complete circle that has an entrance way. The entrance way consists of a pair of curved members biased toward each other, and a recess channel accessible by an aperture 126 on the top side 103 of the horizontal member 102. The placement of integral retention mechanisms 366 and 368 on the bottom side 353 provide a measure of safety when excessive force is applied downward on a retained hose or water line, such as when stepped on or driven over with farming equipment. In those circumstances, the hose or water line can disengage from the integral retention device due to the deformation of the hose or water line to exit the recess channel. This avoids excessive forces being applied to the hose and water line support device 350, thereby reducing breakage in the field.

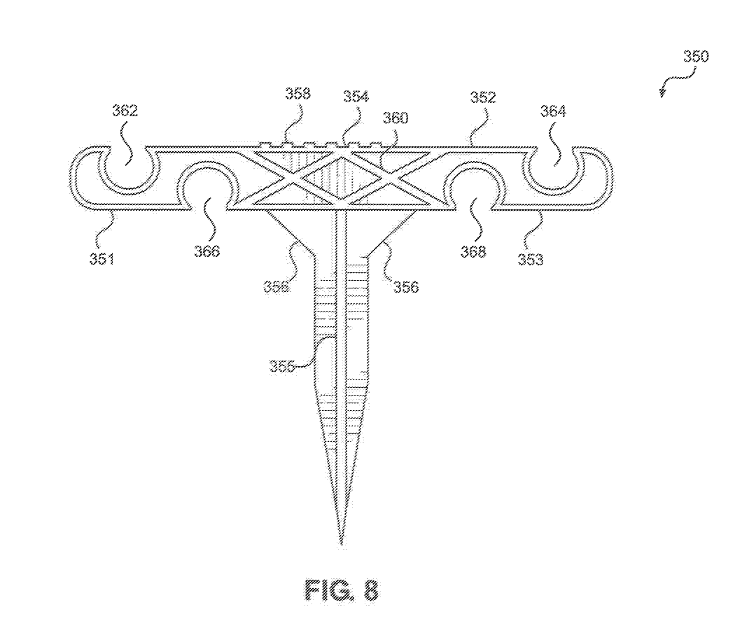

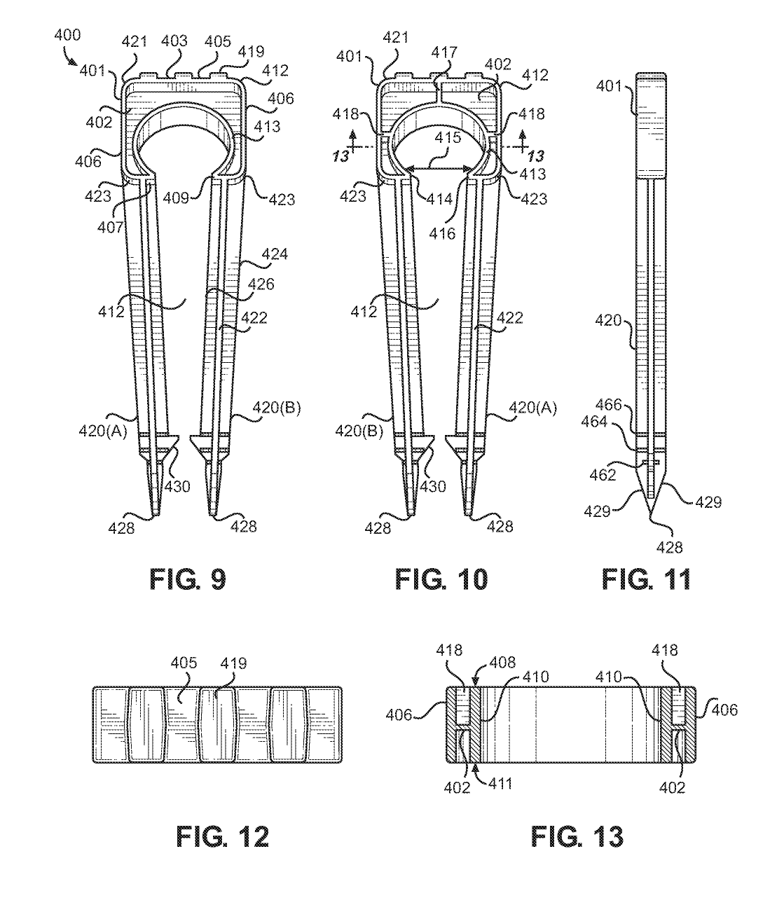

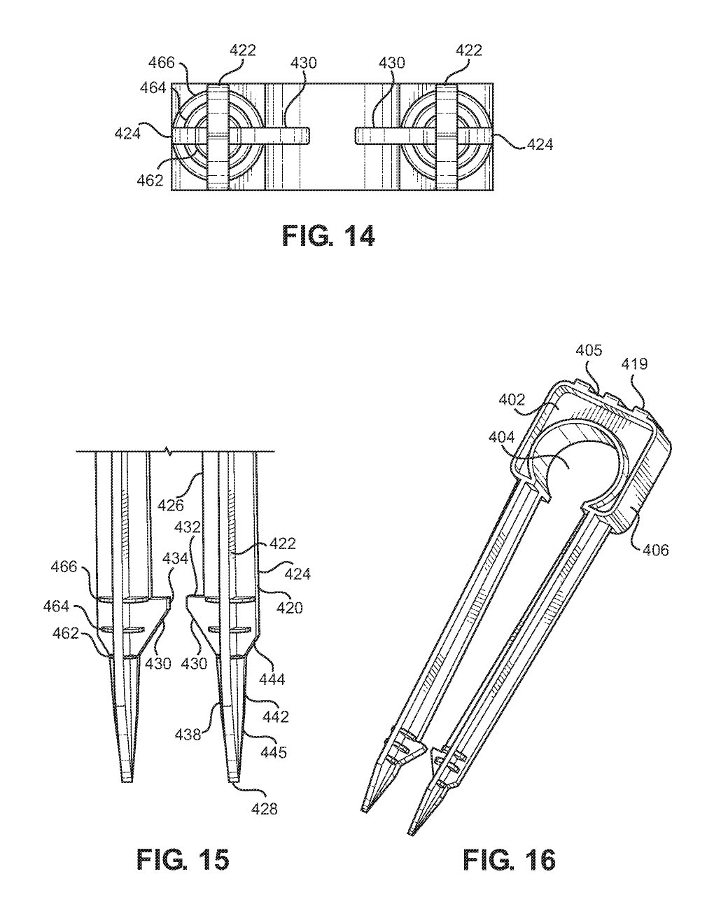

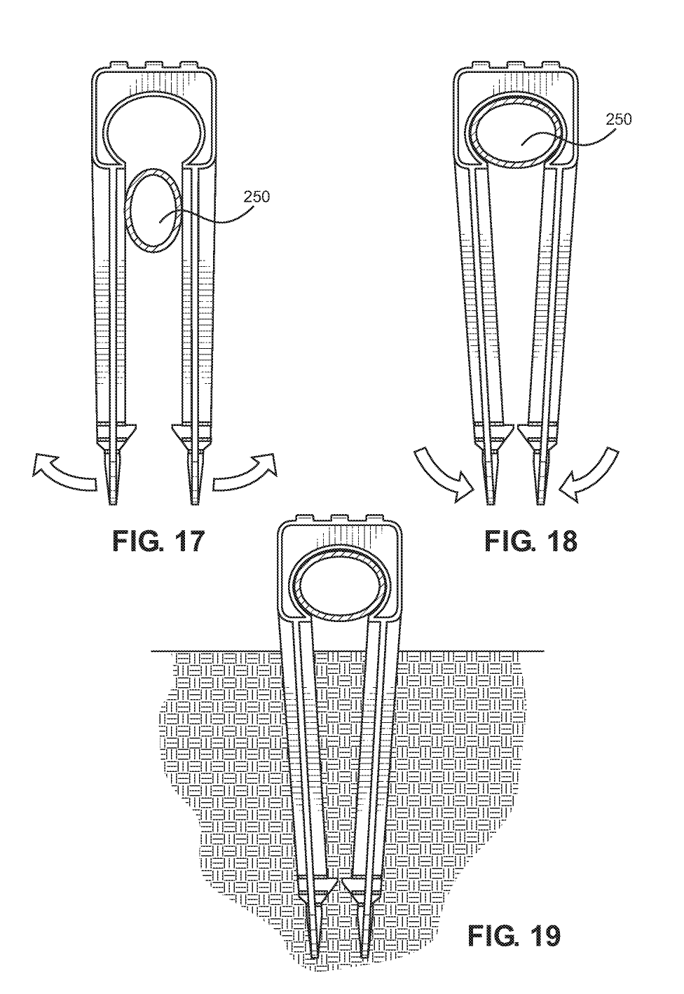

Referring now to FIGS. 9 through 19, an embodiment of a water support device is generally designated 400. The water support device 400 includes a body 401 connected to a pair of stakes 420, made up of first stake 420a and second stake 420b. As with the preceding embodiment, the body 401 is formed with a central member 402 having a water line receiving aperture 404 open between the first stake 420a and the second stake 420b. The first stake 420a and second stake 420b form a channel 412 between the first stake 420a and the second stake 420b, the channel 412 leading to the water line receiving aperture 404.

The central member 402 is reinforced with a body exterior reinforcement 403 having an upper horizontal portion 405, left and right vertical side portions 406, a left lower horizontal portion 407 and a right lower horizontal portion 409, all transversely connected to an outer edge of the central member 402 so as to fully reinforce the entire outer perimeter edge of the central member 402. The left and right vertical side portions 406 are connected to the upper horizontal portion 405 at left and right upper fillets 421 respectively. The left and right vertical side portions 406 are also connected to the left lower horizontal portion 407 and the right lower horizontal portion 409 and left and right lower fillets 423 respectively. The upper and lower fillets 421 and 423 further increase the reinforcement capability of the body exterior reinforcement 403.

Similarly, the central member 402 also has a body interior reinforcement 410 along an interior edge of the central member 402, forming a curved surface 413 of the water line receiving aperture 404. The body interior reinforcement 410 is also transverse to the central member 402 and reinforces the curved surface 413 of the central member 402, thereby forming the water line receiving aperture 404.

As can be seen more fully in connection with FIG. 13, the body exterior reinforcement 403 has a body exterior reinforcement width 408 and the body interior reinforcement 410 has a body interior reinforcement width 411. In order to optimize reinforcement of the central member 402, the body exterior reinforcement width 408 is approximately the same dimension as the body interior reinforcement width 411 with the central member 402 centered at the midpoint of the body exterior reinforcement 410 and the midpoint of the body interior reinforcement 412. The body exterior reinforcement 403 is connected to the body interior reinforcement 410 at first entrance tip 414 and second entrance tip 416. The first entrance tip 414 and the second entrance tip 416 are spaced apart from one another so as to form an entrance 415 to the water line receiving aperture 404. The entrance 415 is slightly narrower than the outer diameter of the flexible water line 250 intended to be secured within the water line receiving aperture 404.

The upper horizontal portion 405 of the body exterior reinforcement is formed with a textured surface 419 that is raised above the surface of the upper horizontal portion 405. The purpose of the textured surface 419 is to minimize slippage when the texture surface 419 is struck by a tool, such as a hammer, when the water line support device is driven into the ground. It is to be appreciated by those skilled in the art that the textured surface 419 disclosed herein is by no means limiting, and the numerous different anti-slip textures and materials could be substituted for the textured surface 419 disclosed herein.

The body is further reinforced with vertical body supplemental bracing 417 connecting the upper horizontal portion 405 of the body exterior reinforcement 403 to the body interior reinforcement 410 and horizontal body supplemental bracing 418 connecting the vertical side portions 406 of the body exterior reinforcement 403 to the body interior reinforcement 410. The vertical body supplemental bracing 417 and the horizontal supplemental bracing 418 are also connected to the surface of the central member 402.

The pair of stakes 420 is each formed with a primary stake member 422 terminating in a pointed distal tip 428. As shown, the pointed distal tip 428 is formed with a primary stake taper 429. Each primary stake member 422 is reinforced by an exterior stake reinforcement member 424 and an interior stake reinforcement member 426.

Each exterior stake reinforcement member 424 is transversely connected to and along the exterior of one of the primary stake members 422. The first end of one exterior stake reinforcement member 424 is connected at the left lower horizontal portion 407 of the body exterior reinforcement 403 of the body 401, with the opposite end tapering until terminating in a pointed end 445 flush with the side of the primary stake member 422. The other exterior stake reinforcement member 424 is connected to the right lower horizontal portion 409 of the body exterior reinforcement 403 of the body 401 with the opposite end tapering until terminating in a pointed end 445 flush with the side of the primary stake member 422. The pointed ends 445 of the exterior stake reinforcement members 424 are aligned with, but not adjacently connected to, the pointed distal tips 428. This configuration allows the primary stake taper 429 to penetrate the ground before the pointed ends 445 of the exterior stake reinforcement member 424 penetrate the ground, thereby allowing the pair of stakes 420 to penetrate the ground more easily.

Each interior stake reinforcement member 426 is transversely connected to and along the interior of one of the primary stake members 422. The first end of one interior stake reinforcement member 426 is connected at the left lower horizontal portion 407 of the body exterior reinforcement 403 of the body 401, with the opposite end terminating in a retention tab 430. The other interior stake reinforcement member 426 is connected to the right lower horizontal portion 409 of the body exterior reinforcement 403 of the body 401, with the opposite end terminating in a retention tab 430. The retention tabs 430 are each formed with a retention tab top 432, retention tab edge 434, and retention tab first taper 436 and a retention tab second taper 438 with the retention tab second taper 438 terminating flush with the inside surface of the primary stake member 422. The retention tab first taper 436 and retention tab second taper 438 facilitate the placement of the stakes into the ground while minimizing the stress on the retention tabs 430.

Semi-circular anchors 462, 464, and 466 are formed between the primary stake member 422, the exterior stake reinforced member 424 and the interior stake reinforcement member 426. The first semi-circular anchor 462 is smaller in dimension than the second semi-circular anchor 464, and the second semi-circular anchor 464 is smaller in dimension than the third semi-circular anchor 466. The semi-circular anchors 462, 464, and 466 are positioned adjacent the retention tab 430 with the first semi-circular anchor 462 positioned adjacent the retention tab first taper 436 and the third semi-circular anchor 466 positioned adjacent the retention tab top 432 with the second semi-circular anchor 464 positioned between the first semi-circular anchor 462 and the third semi-circular anchor 466.

During use, the stakes 420 are flexed about the body 401 sufficiently to enable a flexible water irrigation line 250 to pass between the retention tabs 430, into the channel 412 and ultimately into the water line receiving aperture 404. In order to pass the water line 250 into the water line receiving aperture 404, the water line 250 must be slightly deformed so as to fit into the entrance 415 of the water line receiving aperture 404. Once placed in the water line receiving aperture 404, the water line 250 returns to its ordinary configuration and the water line support device is ready for insertion into the ground by striking the textured surface 419 with a striking object, such as a hammer. The textured surface 419 limits slippage of the striking object when striking the water line support device 400 into the ground. The water line support device 400 is driven into the ground until approximately ⅔ of the length of the stakes 420 is under the ground surface thereby ensuring that the water line is held above the ground surface. Alternatively, the water line support device 400 can be driven into the ground up to the lower horizontal portions 407 and 409 of the body exterior reinforcement 403. At either depth, over time, soil settlement above the semi-circular anchors 462, 464, and 466 and the retention tabs 430 increase the force necessary to remove the water line support device 400 from the ground.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated. While there have been shown what are presently considered to be the preferred embodiment of the present invention, it will be apparent to those skilled in the art that various changes and modifications can be made herein without departing from the scope and spirit of the invention.

What we claim is:

1. A water line support device comprising:
a body having a central member with an outer edge and formed with a water line receiving aperture having an interior edge, wherein the central member is reinforced with a body exterior reinforcement transverse to and along the outer edge and reinforced with a body interior reinforcement transverse to and along the interior edge; and
a first stake and a second stake, each connected to and extending away from the body so as to form a channel between the first stake and the second stake enabling a water line to pass into the channel to the water line receiving aperture.

2. The water line support device of claim 1 wherein the first stake and the second stake each further comprise a primary stake member with a first end connected to the body exterior reinforcement opposite a second end with a taper to a pointed distal tip, an exterior stake reinforcement member transversely connected to and along an exterior surface of the primary stake member, and an interior stake reinforcement member transversely connected to and along an interior surface of the primary stake member.

3. The water line support device of claim 1 wherein the body exterior reinforcement has a body exterior reinforcement width and the body interior reinforcement has a body interior reinforcement width that is the same dimension as the body exterior reinforcement width and wherein the central member is centered on a midpoint of the body exterior reinforcement width and the body interior reinforcement width.

4. The water line support device of claim 2 further comprising a retention tab connected to each of the interior stake reinforcement members adjacent the taper of the primary stake member wherein the retention tabs are positioned opposite one another.

5. The water line support device of claim 2 further comprising at least one or more semi-circular anchors located on the first stake and the second stake, each formed between the primary stake member, the exterior reinforced stake member, and the interior stake reinforced member.

6. The water line support device of claim 4 wherein each of the retention tabs has a retention tab taper terminating flush with an inside surface of the primary stake member of both the first stake and the second stake.

7. The water line support device of claim 4 wherein each of the retention tabs has a first retention tab taper adjacent a second retention tab taper with the second retention tab taper terminating flush with an inside surface of the primary stake member of both the first stake and the second stake.

8. The water line support device of claim 1 wherein the body exterior reinforcement comprises an upper horizontal portion, a left vertical side portion and a right vertical side portion, a left lower horizontal portion and a right lower horizontal portion wherein the left vertical side portion is connected to the upper horizontal portion at an upper left fillet, the right vertical side portion is connected to the upper horizontal portion at an upper right fillet, the left vertical side portion is connected to the left lower horizontal portion at a lower left fillet, and the right vertical side portion is connected to the right lower horizontal portion at a lower right fillet.

9. The water line support device of claim 8 wherein the body exterior reinforcement is connected to the body interior reinforcement at a first entrance tip and a second entrance tip wherein the first entrance tip and the second entrance tip are spaced apart from one another so as to form an entrance to the water line receiving aperture, the entrance dimensioned slightly narrower than an outer diameter or the water line.

10. The water line support device of claim 3 wherein the exterior stake reinforcement member of the left stake and the right stake has a first end connected to the left lower horizontal portion and the first lower horizontal portion of the body exterior reinforcement respectively and an opposite end tapering until terminating in a pointed end flush with an exterior side of the primary stake member.

11. A water line support device comprising:
a body having a central member with an outer edge and formed with a water line receiving aperture having an interior edge, wherein the central member is reinforced with a body exterior reinforcement transverse to and along the outer edge and reinforced with a body interior reinforcement transverse to and along the interior edge, wherein the body exterior reinforcement has a body exterior reinforcement width and the body interior reinforcement has a body interior reinforcement width that is the same dimension as the body exterior reinforcement width and wherein the central member is centered on a midpoint of the body exterior reinforcement width and the body interior reinforcement width;
a first stake and a second stake, each connected to and extending away from the body so as to form a channel between the first stake and the second stake enabling a water line to pass into the channel to the water line receiving aperture, the first stake and the second stake further having a primary stake member with a first end connected to the body exterior reinforcement opposite a second end with a taper to a pointed distal tip, an exterior stake reinforcement member transversely connected to and along an exterior surface of the primary stake member, and an interior stake reinforcement member transversely connected to and along an interior surface of the primary stake member;
a retention tab connected to each of the interior stake reinforcement members adjacent the taper of the primary stake member wherein the retention tabs are positioned opposite one another; and
one or more semi-circular anchors located on the first stake and the second stake formed between the primary stake member, the exterior reinforced stake member, and the interior stake reinforced member.

12. The water line support device of claim 11 wherein each of the retention tabs has a first retention tab taper adjacent a second retention tab taper with the second retention tab taper terminating flush with an inside surface of the primary stake member of both the first stake and the second stake.

13. The water line support device of claim 11 wherein the body exterior reinforcement comprises an upper horizontal portion, a left vertical side portion and a right vertical side portion, a left lower horizontal portion and a right lower horizontal portion wherein the left vertical side portion is connected to the upper horizontal portion at an upper left fillet, the right vertical side portion is connected to the upper horizontal portion at a right upper fillet, the left vertical side portion is connected to the left lower horizontal portion at a lower left fillet, and the right vertical side portion is connected to the right lower horizontal portion at a lower right fillet.

14. The water line support device of claim 13 further comprising a horizontal supplemental bracing connecting the left vertical side portion and the right vertical side portion of the exterior reinforcement member to the interior reinforcement member and vertical supplemental bracing connecting the upper horizontal portion of the body exterior reinforcement to the interior reinforcement member.

15. The water line support device of claim 14 wherein the body exterior reinforcement is connected to the body interior reinforcement at a first entrance tip and a second entrance tip wherein the first entrance tip and the second entrance tip are spaced apart from one another so as to form an entrance to the water line receiving aperture, the entrance dimensioned slightly narrower than an outer diameter or the water line.

16. The water line support device of claim 15 wherein the exterior stake reinforcement member of the left stake and the right stake has a first end connected to the left lower horizontal portion and the first lower horizontal portion of the body exterior reinforcement respectively and an opposite end tapering until terminating in a pointed end flush with an exterior side of the primary stake member.

17. A water line support device comprising:
a body having a central member with an outer edge and formed with a water line receiving aperture having an interior edge, wherein the central member is reinforced with a body exterior reinforcement transverse to and along the outer edge and reinforced with a body interior reinforcement transverse to and along the interior edge, wherein the body exterior reinforcement has a body exterior reinforcement width and the body interior reinforcement has a body interior reinforcement width that is the same dimension as the body exterior reinforcement width and wherein the central member is centered on a midpoint of the body exterior reinforcement width and the body interior reinforcement width;
a first stake and a second stake, each connected to and extending away from the body so as to form a channel between the first stake and the second stake enabling a water line to pass into the channel to the water line receiving aperture, the first stake and the second stake further having a primary stake member with a first end connected to the body exterior reinforcement opposite a second end with a taper to a pointed distal tip, an exterior stake reinforcement member transversely connected to and along an exterior surface of the primary stake member, and an interior stake reinforcement member transversely connected to and along an interior surface of the primary stake member; and
one or more semi-circular anchors located on the first stake and the second stake formed between the primary stake member, the exterior reinforced stake member, and the interior stake reinforced member.

18. The water line support device of claim 17 wherein the body exterior reinforcement comprises an upper horizontal portion, a left vertical side portion and a right vertical side portion, a left lower horizontal portion and a right lower horizontal portion wherein the left vertical side portion is connected to the upper horizontal portion at an upper left fillet, the right vertical side portion is connected to the upper horizontal portion at a right upper fillet, the left vertical side portion is connected to the left lower horizontal portion at a lower left fillet, and the right vertical side portion is connected to the right lower horizontal portion at a lower right fillet and wherein the upper horizontal portion of the body exterior reinforcement has a textured surface.

19. The water line support device of claim 18 wherein the body exterior reinforcement is connected to the body interior reinforcement at a first entrance tip and a second entrance tip wherein the first entrance tip and the second entrance tip are spaced apart from one another so as to form an entrance to the water line receiving aperture, the entrance dimensioned slightly narrower than an outer diameter or the water line.

20. The water line support device of claim 19 wherein the exterior stake reinforcement member of the left stake and the right stake has a first end connected to the left lower horizontal portion and the first lower horizontal portion of the body exterior reinforcement respectively and an opposite end tapering until terminating in a pointed end flush with an exterior side of the primary stake member.
